(19) United States
(12) Patent Application Publication
(10) Pub. No.: US 2006/0127754 A1
(43) Pub. Date: Jun. 15, 2006

(54) Battery pack

(75) Inventors: Shinji Hamada, Toyohashi-shi (JP); Toyohiko Eto, Toyota-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Toyota Jidosha Kabushiki Kaisha.

(21) Appl. No.: 11/299,771

(22) Filed: Dec. 13, 2005

(30) Foreign Application Priority Data
Dec. 14, 2004 (JP) 2004-360723

(51) Int. Cl. H01M 2/24; H01M 6/42

(52) U.S. Cl. 429/158; 429/160

(57) ABSTRACT

A battery pack in which adjoining battery modules are electrically connected is provided with higher reliability of connection and at lower cost than before. A battery pack comprises a plurality of battery modules each including a plurality of sealed batteries. Of the battery modules, a first connecting cell of a first battery module and a second connecting cell of a second battery module are disposed each other in adjoining relation. An external positive terminal of the first connecting cell, serving as a positive electrode, and a second side surface of the second connecting cell, serving as a negative electrode, are electrically connected with each other by a connecting member having extended parts and a plate-like part.

### BACKGROUND OF THE INVENTION

1. Field of the Invention

The present invention relates to a battery pack comprising a plurality of battery modules each including a cell(s) and, more particularly, to a battery pack in which a positive electrode area and a negative electrode area of adjoining battery modules are electrically connected with each other.

2. Description of Related Art

Heretofore, there has been known a battery pack in which a plurality of battery modules each including a plurality of cells are arranged in adjoining relation, and positive electrode areas and the negative electrode areas of those battery modules are electrically connected with each other.

For instance, there is a battery pack 900 shown in FIG. 8. This battery pack 900 comprises a plurality of battery modules 920 each of which is constituted of a plurality of sealed batteries (cells) 910 connected in series. Each sealed battery 910 has a battery case 911 of a rectangular parallelepiped shape, which is entirely used as a negative electrode. On this battery case 911, an external positive terminal 913 serving as a positive electrode is fixed as electrically insulated from the battery case 910. In each battery module 920, the sealed batteries 910 are electrically connected in series and in line such that an external positive terminal 913 of one sealed battery (a first sealed battery) 910 is connected with an end surface 911b of another sealed battery (a second sealed battery) 910 adjoining the first sealed battery 910. The battery modules 920 are arranged in parallel so that the positive electrode (the external positive terminal 913) and the negative electrode (the end surface 911b of the battery case 911) of the adjoining battery modules 920 are oriented in opposite directions.

Of the sealed batteries 910 in each battery module 920, the external positive terminal 913 of the first sealed battery 910 having the highest potential is welded with a positive electrode columnar member 950. Of the sealed batteries 910 of each battery module 920, the end surface 911b of the second sealed battery 910 having the lowest potential is welded with a negative electrode columnar member 960. In the assembled battery pack 900, an insulating case 973 with a plurality of bus bars 971 contained therein is secured with nuts 975 to the positive columnar member 950 and the negative columnar member 960 arranged in adjoining relation.

In the conventional battery pack 900 configured as above, the positive columnar member 950 is provided to the external positive terminal 913 of each battery module 920 and the negative columnar member 960 is provided to the end surface 911b serving as the negative electrode of the whole battery modules 920. Further, the adjoining positive and negative columnar members 950 and 960 are electrically connected with each other by the bus bars 971, the insulating case 973, and the nuts 975.

As another prior art document, there is Japanese unexamined patent application publication No. 2001-57196.

In the battery pack 900 shown in FIG. 8, however, it is necessary to provide the electrode columnar member (the positive columnar members 950 or the negative columnar member 960) in each of the battery modules 920. It is accordingly necessary to provide the bus bars 971, the insulating case 973, and the nuts 975. This likely causes an increase in parts cost and assembling cost for connection of the battery modules 920 with each other. Thus, the battery pack 900 results in high cost.

### SUMMARY OF THE INVENTION

The present invention has been made in view of the above circumstances and to provide a battery pack comprising battery modules electrically connected with adjoining ones, designed for achieving high connecting reliability and lower costs than conventional battery packs.

To achieve the purpose of the invention, there is provided a battery pack comprising a plurality of battery modules each including one or more cells, wherein the plurality of battery modules includes a first and second battery modules arranged in adjoining relation, the cell(s) of the first battery module include a first connecting cell connected with the second battery module and the cell(s) of the second battery module include a second connecting cell connected with the first connecting cell of the first battery module, the first and second connecting cells being arranged in adjoining relation, and the first connecting cell includes a positive electrode area serving as a positive electrode and the second connecting cell includes a negative electrode area serving as a negative electrode, and the positive electrode area and the negative electrode area are electrically connected with each other by a connecting member integrally including a positive electrode weld part welded to the positive electrode area and a negative electrode weld part welded to the negative electrode area.

According to the present invention, in the adjoining first and second battery modules, the positive electrode area of the first connecting cell belonging to the first battery module is electrically connected with the negative electrode area of the second connecting cell belonging to the second battery module by the connecting member integrally having the positive electrode weld part welded to the positive electrode area and the negative electrode weld part welded to the negative electrode area. In such battery pack, the battery modules are electrically connected with each other by the connecting member, so that there is no need to provide the columnar members as in the conventional battery pack and secure the battery modules with a bus bar, insulating case, and nuts. Thus, parts const and assembling cost for connection of the battery modules can be reduced. The battery pack can therefore be provided with high reliability of connection between the battery modules and at lower cost.

The “connecting member” is required only to integrally include, as mentioned above, the positive electrode weld part to be welded to the positive electrode area of the first connecting cell and the negative electrode weld part to be welded to the negative electrode area of the second connecting cell, and to electrically connect those positive and negative electrode areas. The shape and material of the connecting member may be appropriately chosen. To provide the battery pack at lower cost, it is preferable to utilize the connecting member made in one-piece of a conductive material in a simple shape.

In the above battery pack, preferably, each cell is of a rectangular parallelepiped shape, each battery module includes a plurality of the cells which are electrically connected in series and in line, the battery modules are arranged in parallel with each other, the first connecting cell is a cell having the highest potential, of the cells of the first battery module, the second connecting cell is a cell having the lowest potential, of the cells of the second battery module, the positive electrode area is positioned within an external positive terminal formed on a first case wall of the first connecting cell, the first case wall forming an end of the first battery module in a direction of arrangement of the cells in line, the negative electrode area is positioned within a second case wall of the second connecting cell, the second case wall forming an end of the second battery module in a direction of arrangement of the cells in line, and the first case wall of the first connecting cell and the second case wall of the second connecting cell are arranged in the same imaginary plane.

According to the present invention, each battery module includes the cells each having a rectangular parallelepiped shape arranged in line, and also the battery modules are arranged in line. The positive electrode area is positioned within the external positive terminal formed on the first case wall of the first connecting cell and the negative electrode area is positioned within the second case wall of the second connecting cell. Further, these first and second case walls are positioned flush with each other, i.e., in the same imaginary plane. Since the cells have the above relation, the connecting member for connecting the positive electrode area positioned in the external positive terminal and the negative electrode area positioned in the second case wall may be formed in a simple shape. Further, the positive electrode area in the external positive terminal and the positive electrode welding area of the connecting member can be easily welded to each other. Also, the negative electrode area in the second case wall and the negative electrode welding area of the connecting member can be easily welded to each other.

In the above battery pack, further preferably, the connecting member includes a variation-absorbing part formed between the positive electrode weld part and the negative electrode weld part, the variation-absorbing part including a structure for absorbing variations in connection distance between the positive electrode area and the negative electrode area to maintain connection therebetween.

Variations in size between the battery modules arranged in adjoining relation may cause a problem that the connecting member cannot be welded to a predetermined position of the battery modules. Also, deformation of the battery case of the cell resulting from thermal expansion during use of the battery pack is likely to variations in distance between the battery modules, imposing a burden on the connecting member which connects the battery modules. This may cause breakage of the connecting member itself and damages to the welded portions of the connecting member and the battery module.

In this present invention, in contrast, the connecting member includes the variation-absorbing part having the structure for absorbing variations in connection distance between the positive and negative electrode weld parts to maintain the connection therebetween. This variation-absorbing part can absorb the variations in size of connection distance occurring at manufacture and variations in connection distance occurring during use, thereby ensuring the connection between the battery modules. Accordingly, the reliability of connection between the battery modules can be improved.

Furthermore, in the above battery pack, preferably, the connecting member is made of a metal plate, and the variation-absorbing part is a variation-absorbing bent part made of the metal plate partly bent into a U-shape or wavy shape.

The above connecting member is required only to include the positive electrode weld part to be welded to the positive electrode area of the first connecting cell and the negative electrode weld part to be welded to the negative electrode area of the second connecting cell, and to electrically connect the positive and negative electrode areas. Thus, the connecting member may be formed appropriately in any shape. However, as its shape becomes complicated, it is hard to produce, leading to high cost.

In contrast, in the present invention, the connecting member is made of a metal plate partly bent into a U-shape or wavy shape, forming the variation-absorbing part. With this configuration, the connecting member can be produced easily and at lower cost. The battery pack also results in lower cost.

In the above battery pack, further preferably, all the battery modules of the battery pack are electrically connected with one another by the connecting members.

As above, when all the battery modules constituting the battery pack are electrically connected with each other by the connecting members, the battery pack can be achieved at lower cost.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a perspective view of a part of a battery pack in a present embodiment;

FIG. 2 is a perspective view of a positive-electrode-side part of a battery module constituting the battery pack in the present embodiment;

FIG. 3 is a perspective view of a negative-electrode-side part of the battery module constituting the battery pack in the present embodiment;

FIG. 4 is a perspective view showing a sealed battery constituting the battery pack in the present embodiment;

FIG. 5 is a perspective view showing a positive electrode columnar member in the battery pack in the present embodiment;

FIG. 6 is a perspective view showing a negative electrode columnar member in the battery pack in the present embodiment;

FIG. 7 is a perspective view showing a connecting member in the battery pack in the present embodiment; and

FIG. 8 is a perspective view of part of a battery pack in a prior art.

### DETAILED DESCRIPTION OF THE PREFERRED EMBODIMENTS

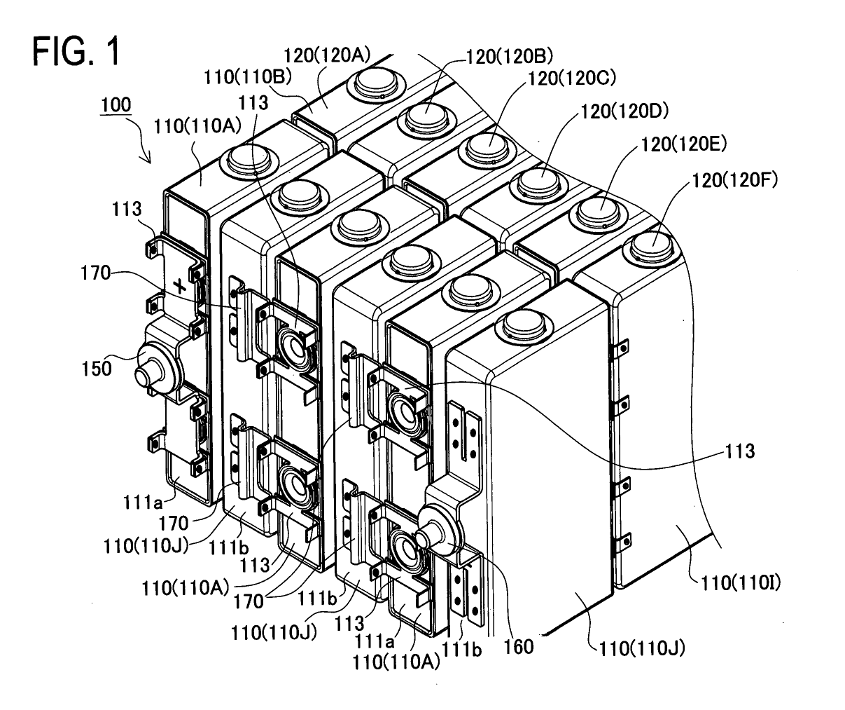

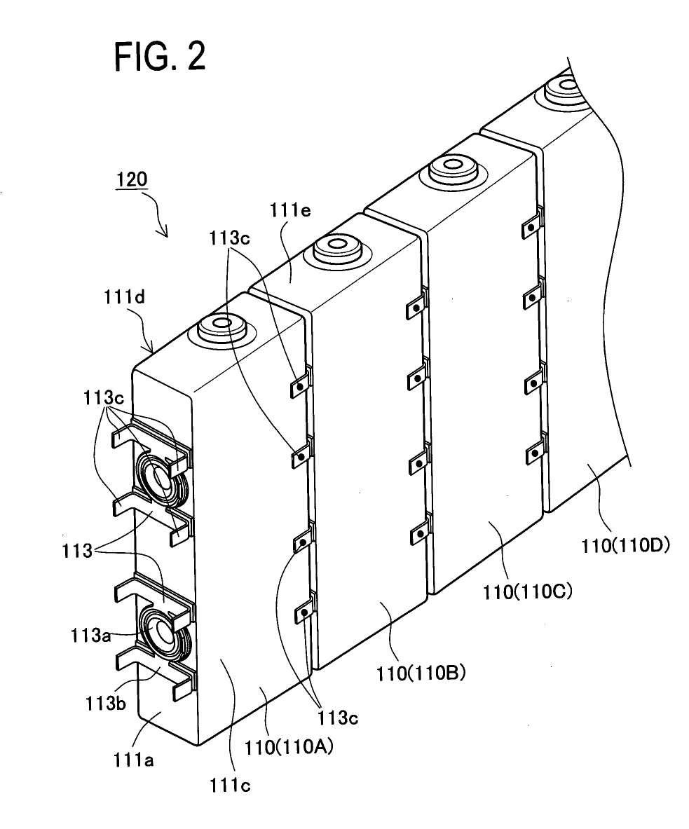

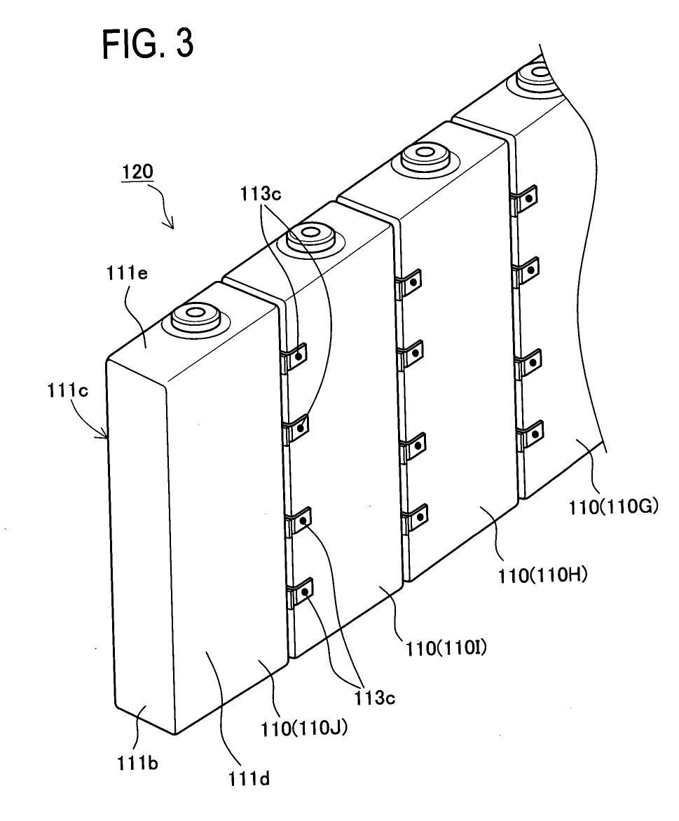

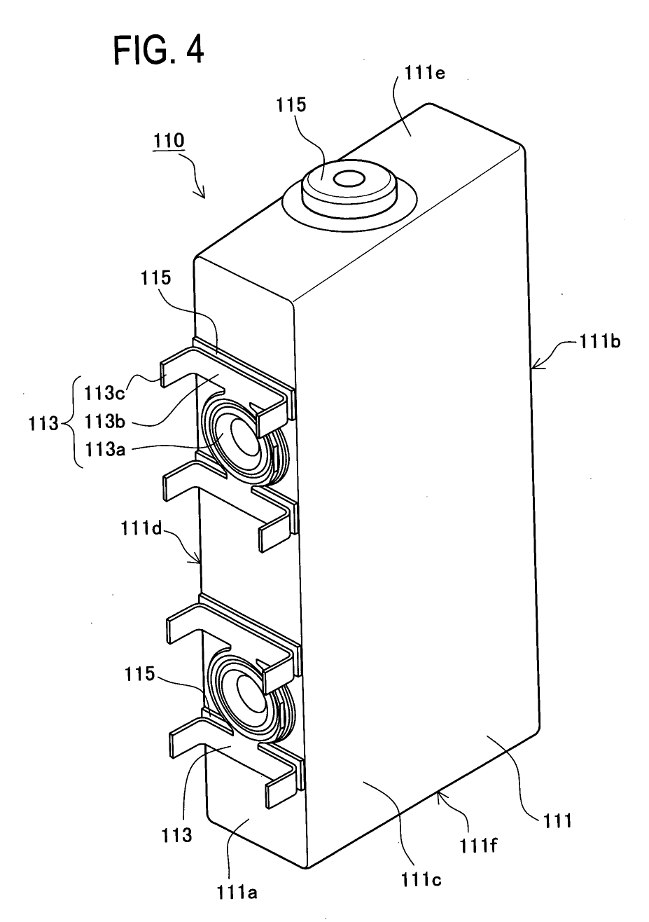

A detailed description of a preferred embodiment of the present invention will now be given referring to the accompanying drawings. FIG. 1 shows a part of a battery pack 100 in the present embodiment. FIG. 2 shows a battery module 120 constituting the battery pack 100, seen from a positive electrode side. FIG. 3 shows the same seen from a negative electrode side. Further, FIG. 4 shows a sealed battery (cell) 110 constituting the battery module 120.

This battery pack 100 is a secondary battery such as nickel hydride secondary battery or lithium ion battery, which will be used as a power source for battery cars and hybrid cars.

As shown in FIG. 4, the sealed battery 110 included in the battery pack 100 is a rectangular battery of a substantially rectangular parallelepiped shape, which comprises a battery case 111 of a rectangular parallelepiped shape, a power generation element (not shown) housed in the battery case 111, external positive terminals 113 fixed to the battery case 111, and others. The case 111 is filled with electrolytic solution.

The battery case 111 is made of a conductive material (nickel-plated steel plate) and has: a first side surface (a first case wall) 111a of a flat, rectangular shape, which faces the lower left in FIG. 4; a second side surface (a second case wall) 111b of the same shape as the first side surface 111a and positioned in parallel therewith, which faces the upper right in FIG. 4; a third side surface 111c and a fourth side surface 111d each of which has a flat, rectangular shape and connects the long sides of the first and second side surfaces 111a and 111b; and a top surface 111e and a bottom surface 111f each of which has a flat, rectangular shape and connects the short sides of the first and second side surfaces 111a and 111b. This battery case 111 is electrically connected to a negative electrode of the power generation element to entirely serve as a negative electrode.

The first side surface 111a is formed with two through holes spaced at a predetermined interval in a lengthwise direction, in each of which the external positive terminal 113 is mounted. These external positive terminals 113 are fixed in an electrically insulated state through a sealing member 115 from the first side surface 111a serving as the negative electrode. Each external positive terminal 113 serves as a positive electrode of the sealed battery 110 when it is electrically connected to the positive electrode of the power generation element through a positive electrode collecting plate not shown. Further, the top surface 111e is centrally formed with a through hole in which a safety valve 115 is mounted.

Each external positive terminal 113 includes a columnar part 113a having a hollow cylindrical shape with a closed end (inside the battery), a terminal flange part 113b extending from an open end (outside the battery) of the columnar part 113a, in parallel with the first side surface 111a of the battery case 111, and four extended weld parts 113c extending from the terminal flange parts 113b in a direction perpendicular to the first side surface 111a of the battery case 111.

The extended weld parts 113c are configured such that, when the sealed batteries 110 are arranged so that the first side surface 111a of one sealed battery (a first sealed battery) 110 faces the second side surface 111b of another sealed battery (a second sealed battery) 110 to bring the external positive terminals 113 of the first sealed battery 110 into contact with the second side surface 111b of the second sealed battery 110, each extended weld part 113c of the first sealed battery 110 overlap from outside with the third and fourth side surfaces 111c and 111d of the second sealed battery 110 (see FIGS. 1 through 3) and is welded thereto. To be concrete, of the four extended weld parts 113c of each external positive terminal 113, two extended weld parts 113c located on the third side surface 111c side overlap from outside with part of the third side surface 111c of the second sealed battery 110 near the boundary with the second side surface 111b of the second sealed battery 110 and are welded thereto. Further, the other two extended weld parts 113c overlap from outside with part of the fourth side surface 111d of the second sealed battery 110 near the boundary with the second side surface 111b and are welded thereto.

The following explanation will be made on the battery module 120 constituted of the sealed batteries 110 (see FIGS. 2 and 3). In the present embodiment, the battery module 120 includes ten sealed batteries 110 (110A to 110J) arranged in line. In the battery module 120, specifically, the external positive terminals 113 of one sealed battery (a first sealed battery) 110 (e.g., 110J in FIG. 3) are connected with the second side surface 111b of the battery case 111 of another adjoining sealed battery (a second sealed battery) 110 (e.g., 110I in FIG. 3) so that the sealed batteries 110 are electrically arranged in series and in line. To be concrete, the columnar parts 113a of the external positive terminals 113 of the first sealed battery 110 are in contact with the second side surface 111b of the second sealed battery 110. Of the four extended weld parts 113c of each external positive terminal 113 of the first sealed battery 110, two extended weld parts 113c located on the third side surface 111c side are welded, in an overlapping state from outside, to the area of the third side surface 111c of the second sealed battery 110 near the boundary with the second side surface 111b (each welded part is shown by a black circle in the figure). The other two extended weld parts 113c are welded, in an overlapping state from outside, to the area of the fourth side surface 111d of the second sealed battery 110 near the boundary with the second side surface 111b (similarly, each welded part is shown by a black circle in the figure).

Of the sealed batteries 110 (110A to 110J) of the battery module 120, the sealed battery 110A having the highest potential (toward a positive potential side), i.e., at the lower left in FIG. 2, corresponds to the “first connecting cell” of the present invention. In this sealed battery 110A, the extended weld parts 113c, eight in total, of the external positive terminals 113 correspond to the “positive electrode area” of the present invention.

In the sealed batteries 110 (110A to 110J) of the battery module 120, the sealed battery 110J having the lowest potential (the highest potential toward a negative potential side), i.e., at the lower left in FIG. 3, corresponds to the “second connecting cell” of the present invention. In this sealed battery 110J, the second side surface 111b corresponds to the “negative electrode area” of the present invention.

The battery pack 100 constituted of the battery modules 120 will be described below, referring to FIG. 1. In the present embodiment, the battery pack 100 includes six battery modules 120 (120A to 120F) assembled into one. The battery modules 120 are arranged in parallel and alternately in opposite directions so that the positive electrode (the external positive terminals 113) and the negative electrode (the second side surface 111b of the battery case 111) of each sealed battery 110 included in the adjoining battery modules 120 are located adjacently. Of the sealed batteries 110 (110A to 110J) in one of the battery modules 120, the sealed battery (the first connecting cell) 110A having the highest potential is arranged in adjoining relation to the sealed battery (the second connecting cell) 110J having the lowest potential of the sealed batteries 110 (110A to 110J) in another battery module 120 adjoining the former battery module 120. Further, the first side surface 111a of the sealed battery (the first connecting cell) 110A and the second side surface 111b of the sealed battery (the second connecting cell) 110J are positioned flush with each other, namely, in the same imaginary plane.

Of the battery modules 120 (120A to 120F) constituting the battery pack 100, the battery modules 120A and 120F located on both end sides are provided with a positive electrode columnar member 150 and a negative electrode columnar member 160 respectively by welding.

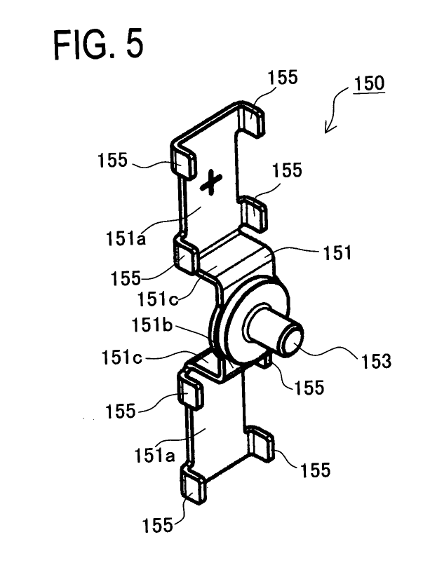

In the battery pack 100, specifically, in the battery module 120A located on one end side (an upper left side in FIG. 1) and having the highest potential (toward the positive potential side) of the battery pack 100, each external positive terminal 113 of the sealed battery 110A (a forward one in FIG. 1) having the highest potential of the battery module 120A is attached with the positive electrode columnar member 150 shown in FIG. 5 by welding. This positive electrode columnar member 150 serves as the positive electrode of the battery pack 100 and will be utilized for connection to an external device.

The positive electrode columnar member 150 includes a body part 151 forming a main body thereof, a rod (a columnar part) 153 which is formed protruding from the body part 151 and will be utilized directly for connection of the battery pack 100 to the external device, and eight extended parts 155 each extending from the body part 151 in the same direction as the rod 153. The body part 151 includes two first plate-like seat parts 151a each having four of the extended parts 155, a second plate-like seat part 151b which is located closer to the rod 153 than the first seat parts 151a and the rod 153 is mounted on, and two plate-like wall parts 151c each connecting one of the first seat parts 151a and the second seat part 151b. The first seat parts 151a are in contact with the external positive terminals 113 of the sealed battery 110 respectively.

The positive electrode columnar member 150 and the external positive terminals 113 of the sealed battery 110A are welded to each other in such a state that the two first seat parts 151a of the positive electrode columnar member 150 are in contact with the corresponding columnar parts 113a of the external positive terminals 113 respectively and also each extended part 155 of the positive electrode columnar member 150 is put inside each extended weld part 113c of the external positive terminal 113 into an overlapping state.

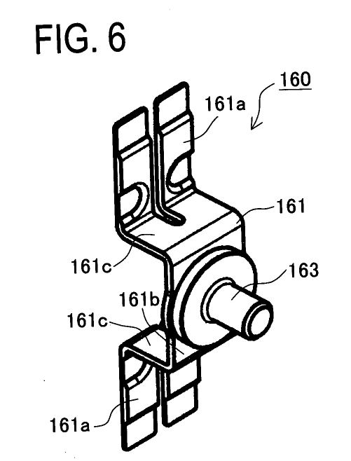

In the battery pack 100, specifically, in the battery module 120F located on the other end side (a lower right side in FIG. 1) and having the lowest potential (the highest potential toward the negative potential side) of the battery pack 100, the sealed battery 110J (a forward one in FIG. 1) having the lowest potential of the battery module 120F is attached, on the second side surface 111b, with the negative electrode columnar member 160 shown in FIG. 6 by welding. This negative electrode columnar member 160 serves as the negative electrode of the battery pack 100 and will be used for connection to the external device.

The negative electrode columnar member 160 includes a body part 161 forming a main body thereof and a rod (a columnar part) 163 which is formed protruding from the body part 161 and will be utilized directly for connection of the battery pack 100 to the external device. The body part 161 includes two first seat parts 161a each having a substantially plate-like shape divided into two parts and is welded to the second side surface 111b of the sealed battery 110. Further, the body part 161 includes a second plate-like seat part 161b which is located closer to the rod 163 than the first seat parts 161a and the rod 163 is mounted on, and two plate-like wall parts 161c each connecting the first and second seat parts 161a and 161b.

The negative electrode columnar member 160 and the second side surface 111b of the sealed battery 110J are welded to each other in such a state that both the two first seat parts 161a of the negative electrode columnar member 160 are in contact with the second side surface 111b of the sealed battery 110J.

Connection between the battery modules 120 (120A to 120F) constituting the battery pack 100 will be explained below, referring to FIG. 1.

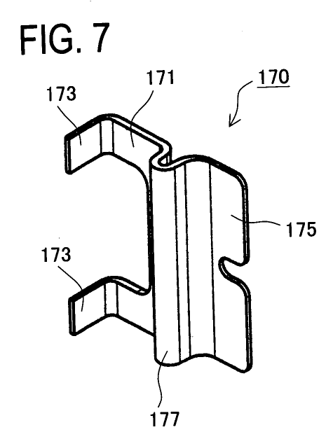

The battery modules 120 (120A to 120F) of the battery pack 100 are electrically connected with each other with connecting members 170 shown in FIG. 7. To be more precise, the external positive terminals 113 of the sealed battery (the first connecting cell) 110A having the highest potential in one (corresponding to the first battery module of the present invention) of the battery modules 120 arranged in adjoining relation and the second side surface 111b of the sealed battery (the second connecting cell) 110J having the lowest potential in the other battery module 120 are connected in series by the connecting members 170.

Although only one end side (a lower left side in FIG. 1) of the battery pack 100 is shown in FIG. 1, it should be understood that on the other end side the battery modules 120 (120A to 120F) are also electrically connected with each other through the connecting members 170. Thus, all the battery modules 120 (120A to 120F) constituting the battery pack 100 are connected in series.

As shown in FIG. 7, each connecting member 170 is formed in one-piece of a metal plate, including a body part 171, two extended parts 173 (corresponding to a “positive-electrode weld part” of the present invention), a plate-like part 175 (corresponding to a “negative-electrode weld part” of the present invention), and a variation-absorbing bent part 177. The body part 171 is of a plate-like shape with two divided ends. The extended parts (the positive electrode weld parts) 173 are provided extending from the divided ends of the body part 171 respectively in a direction perpendicular to the body part 171. The plate-like part (the negative electrode weld part) 175 is located in the same imaginary plane as the body part 171 and provided with two divided ends. The variation-absorbing bent part 177 is formed of a metal plate curved like a letter U connecting the body part 171 and the plate-like part 175. Since the connecting member 170 is made of a metal plate with the bent part 177 curved like the letter U, the connecting member 170 including the bent part 177 can be made easily and at lower cost.

As shown in FIG. 1, each external positive terminal 113 of the sealed battery (the first connecting cell) 110A and each connecting member 170 are welded to each other in such a state that each extended part (the positive electrode weld part) 173 of the connecting member 170 overlap with the outside of each extended weld part (the positive electrode area) 113c of the external positive terminal 113.

On the other hand, the second side surface 111b of the sealed battery (the second connecting cell) 110J and each connecting member 170 are welded to each other in such a state that the plate-like part (the negative electrode weld part) 175 of each connecting member 170 is in contact with the second side surface (the negative electrode area) 111b of the sealed battery 110J.

In the battery pack 100, an insulating sheet not shown in FIG. 1 is interposed between the adjoining battery modules 120 to insulate them from each other. An end plate is also placed on each side of the battery pack 100, i.e., outside each of the battery modules 120A and 120F. The battery pack 100 is entirely bound with a binding band.

In the above mentioned battery pack 100, the sealed battery (the first connecting cell) 110A, which belongs to one of the adjoining battery modules 120 and has the highest potential, and the sealed battery (the second connecting cell) 110J, which belongs to the other battery modules 120 and has the lowest potential, are electrically connected with each other through the connecting members 170. Specifically, the extended parts (the positive electrode areas) 113c of the external positive terminals 113 of the first connecting cell 110A and the second side surface (the negative electrode area) 111b of the second connecting cell 110J are electrically connected by the connecting members 170 integrally including the extended parts (the positive electrode weld parts) 173 welded to the extended weld parts 113c respectively and the plate-like part (the negative electrode weld part) 175 welded to the second side surface 111b.

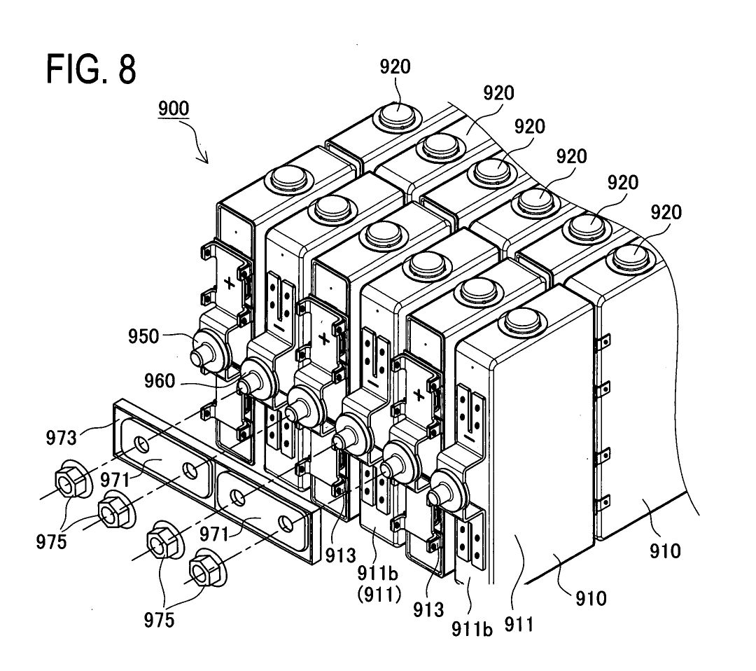

When the adjoining battery modules 120 are connected by the connecting members 170 as above, it is unnecessary to provide the columnar members 950 and 960 to every battery module as in the conventional battery pack 900 (see FIG. 8), which have to be connected by means of the bus bars 971, the insulating case 973, and the nuts 975. Accordingly, the battery pack 100 in the present embodiment can achieve a reduction in parts cost and assembling cost. Consequently, the battery pack 100 can be provided at lower cost while ensuring reliability of connection between the battery modules 120. In the present embodiment, particularly, all the battery modules 120 (120A to 120F) of the battery pack 100 are electrically connected with each other by the connecting members 170, so that the battery pack 100 can be provided at lowest cost.

In the present embodiment, furthermore, the battery modules 120 are arranged in parallel with each other. The extended weld parts (the positive electrode area) 113c are included in each corresponding external positive terminal 113 mounted on the first side surface 111a of the sealed battery (the first connecting cell) 110, while the negative electrode area is the second side surface 111b of the sealed battery (the second connecting cell) 110. The first and second side surfaces 111a and 111b are positioned in the same imaginary plane. Accordingly, each connecting member 170 for connecting each extended weld part (the positive electrode area) 113c and the second side surface (the negative electrode area) 111b can be formed in a simple shape by processing a metal plate as in the above manner. There are further advantages that each extended part (the positive electrode area) 113c and each extended part (the positive electrode weld part) 173 of the connecting member 170 can be welded easily to each other and also that the second side surface (the negative electrode area) 111b and the plate-like part (the negative electrode weld part) 175 of the connecting member 170 can be welded easily to each other.

In the present embodiment, as mentioned above, the connecting member 170 includes the variation-absorbing bent part 177 having a U-shaped section to absorb a variation in connection distance between the extended parts (the positive electrode weld part) 173 and the plate-like part (the negative electrode weld part) 175. Accordingly, even if the connection distance varies between the battery modules 120 when assembled into one, the variation-absorbing bent part 177 is deformed, thereby absorbing the variations in connecting distance. This makes it possible to surely weld the battery modules 120 to each other. The battery case 111 of the sealed battery 110 may be deformed due to thermal expansion during use of the battery pack 100, which may cause variations in the connecting distance between the battery modules 120. However, the variation-absorbing bent part 177 can be deformed to absorb the variations, ensuring connection between the battery modules 120. Consequently, by use of the connecting member 170 with the variation-absorbing bent part 177, it is possible to enhance the reliability of connection between the battery modules 120.

Next, a method of producing the above battery pack 100 will be explained.

The sealed battery 110 shown in FIG. 4 is first produced by a well known technique.

Then, the battery module 120 is produced by connecting the sealed batteries 110 in series. To be concrete, the sealed batteries 110 are arranged such that the first side surface 111a of one (first) sealed battery 110 faces the second side surface 111b of another (second) sealed battery 110, and the external positive terminals 113 of the first sealed battery 110 are brought into contact with the second side surface 111b of the second sealed battery 110. In this state, of the extended weld parts 113c of the external positive terminals 113 of the first sealed battery 110, the extended weld parts 113c located on the third side surface 111c side overlap from outside with the area of the third side surface 111c of the second sealed battery 110 near the boundary with the second side surface 111b. The other extended weld parts 113c overlap from outside with the area of the fourth side surface 111d of the second sealed battery 110 near the boundary with the second side surface 111b.

Then, a laser is irradiated to each extended weld part 113c of the first sealed battery 110 from outside to weld the extended weld parts 113c to the third side surface 111c and the fourth side surface 111d of the second sealed battery 110, thereby connecting the sealed batteries 110 in series. Thus, the battery module 120 shown in FIGS. 2 and 3 is produced. Instead of laser welding, resistance welding may be adopted to connect the sealed batteries 110.

Subsequently, the insulating sheets not shown are interposed one between the battery modules 120 which are arranged in parallel. These battery modules 120 are bound with the end plates and the binding band, both being not shown.

In the battery pack 100, the positive electrode columnar member 150 shown in FIG. 5 is welded to the sealed battery 110A having the highest potential of the battery module 120A (an upper left one in FIG. 1) having the highest potential of the battery pack 100. To be more precise, the two first seat parts 151a of the positive electrode columnar member 150 are brought into contact with the corresponding columnar parts 113a of the external positive terminals 113 of the sealed battery 110A. Simultaneously, the four extended parts 155 of the positive electrode columnar member 150 put in contact with the inside of the corresponding extended weld parts 113c of the external positive terminal 113 respectively. A laser is then irradiated individually to the extended weld parts 113c of each external positive terminal 113 to weld the extended weld parts 113c to the corresponding extended parts 155 of the positive electrode columnar member 150, thereby fixing this columnar member 150 to the external positive terminals 113. This welding may be conducted by resistance welding.

In the battery pack 100, the negative electrode columnar member 160 shown in FIG. 6 is welded to the sealed battery 110J having the lowest potential of the battery module 120F (a lower right one in FIG. 1) having the lowest potential of the battery pack 100. To be concrete, the two first seat parts 161a of the negative electrode columnar member 160 are brought into contact with predetermined areas of the second side surface 111b of the sealed battery 110J. Then, a laser is irradiated to the two first seat parts 161a from outside to weld each first seat part 161a to the second side surface 111b, thereby fixing the negative electrode columnar member 160 to the second side surface 111b. Instead of the laser welding, resistance welding may be adopted.

The battery modules 120 are directly connected with each other by the connecting members 170. Specifically, the extended parts (the positive electrode weld part) 173 of the connecting member 170 are put in contact with the outside of the extended weld parts (the positive electrode area) 113c of the external positive terminals 113 of the sealed battery (the first connecting cell) 110 having the highest potential of one battery module (the first battery module) 120. Simultaneously, the plate-like part (the negative electrode weld part) 175 of the connecting member 170 is brought into contact with the predetermined area of the second side surface (the negative electrode area) 111b of the sealed battery (the second connecting cell) 110J having the lowest potential of another battery module (the second battery module) 120 adjoining the above battery module 120. Sequentially, a laser is irradiated to the extended parts (the positive electrode weld part) 173 of the connecting member 170 individually to weld the extended parts 173 to the extended parts 113c of the external positive terminal 113, thereby fixing the connecting member 170 to the external positive terminal 113. Further, a laser is irradiated to the plate-like part (the negative electrode weld part) 175 of the connecting member 170 to weld the plate-like part 175 to the second side surface (the negative electrode area) 111b, thereby fixing the connecting member 170 to the second side surface 111b. This welding may also be performed by resistance welding. Consequently, the battery pack 100 is completed.

The present invention may be embodied in other specific forms without departing from the spirit or essential characteristics thereof.

For instance, in the above embodiment, the external positive terminal 113 is provided with the extended weld parts 113c serving as the positive electrode area, which are welded to the extended parts (the positive electrode weld part) 173 of the connecting member 170. As an alternative, the external positive terminal may be configured with no extended weld parts 113c, and such external positive terminal may be welded to the connecting member.

What is claimed is:

1. A battery pack comprising a plurality of battery modules each including one or more cells,
wherein the plurality of battery modules includes a first and second battery modules arranged in adjoining relation,
the cell(s) of the first battery module include a first connecting cell connected with the second battery module and the cell(s) of the second battery module include a second connecting cell connected with the first connecting cell of the first battery module, the first and second connecting cells being arranged in adjoining relation, and
the first connecting cell includes a positive electrode area serving as a positive electrode and the second connecting cell includes a negative electrode area serving as a negative electrode, and the positive electrode area and the negative electrode area are electrically connected with each other by a connecting member integrally including a positive electrode weld part welded to the positive electrode area and a negative electrode weld part welded to the negative electrode area.

2. The battery pack according to claim 1, wherein
each cell is of a rectangular parallelepiped shape,
each battery module includes a plurality of the cells which are electrically connected in series and in line,
the battery modules are arranged in parallel with each other,
the first connecting cell is a cell having the highest potential of the cells of the first battery module,
the second connecting cell is a cell having the lowest potential of the cells of the second battery module,
the positive electrode area is positioned within an external positive terminal formed on a first case wall of the first connecting cell, the first case wall forming an end of the first battery module in a direction of arrangement of the cells in line,
the negative electrode area is positioned within a second case wall of the second connecting cell, the second case wall forming an end of the second battery module in a direction of arrangement of the cells in line, and
the first case wall of the first connecting cell and the second case wall of the second connecting cell are arranged in the same imaginary plane.

3. The battery pack according to claim 1, wherein
the connecting member includes a variation-absorbing part formed between the positive electrode weld part and the negative electrode weld part, the variation-absorbing part including a structure for absorbing variations in connection distance between the positive electrode area and the negative electrode area to maintain connection therebetween.

4. The battery pack according to claim 3, wherein
the connecting member is made of a metal plate, and
the variation-absorbing part is a variation-absorbing bent part made of the metal plate partly bent into a U-shape or wavy shape.

5. The battery pack according to claim 2,
the connecting member includes a variation-absorbing part formed between the positive electrode weld part and the negative electrode weld part, the variation-absorbing part including a structure for absorbing variations in connection distance between the positive electrode area and the negative electrode area to maintain connection therebetween.

6. The battery pack according to claim 5,
the connecting member is made of a metal plate, and
the variation-absorbing part is a variation-absorbing bent part made of the metal plate partly bent into a U-shape or wavy shape.

7. The battery pack according to claim 1, wherein
all the battery modules of the battery pack are electrically connected with one another by the connecting members.
